(19) United States
(12) Patent Application Publication
(10) Pub. No.: US 2025/0153365 A1
(43) Pub. Date: May 15, 2025

(54) DELIVERING FOAM CONCENTRATE VIA A TANK THAT MOUNTS TO A VEHICULAR ROBOT

(71) Applicant: Howe & Howe Inc., Waterboro, ME (US)

(72) Inventors: Timothy Merlin Foley, Lyman, ME (US); Michael J. Zagorianakos, Buxton, ME (US)

(21) Appl. No.: 18/931,941

(22) Filed: Oct. 30, 2024

Related U.S. Application Data
(60) Provisional application No. 63/598,648, filed on Nov. 14, 2023.

(51) Int. Cl. B25J 11/00; A62C 27/00; A62C 99/00; B25J 5/00

(52) U.S. Cl. CPC B25J 11/008; A62C 27/00; A62C 99/0036; B25J 5/007

(57) ABSTRACT

Techniques are directed to provisioning a vehicular robot with foam concentrate. Such techniques involve mounting a foam concentrate tank assembly to the vehicular robot. The assembly includes:
(i) a set of metal partitions defining a chamber to hold foam concentrate,
(ii) a set of baffles disposed within the chamber and coupled with the set of metal partitions, and
(iii) a set of mounting members external to the chamber and coupled with the set of metal partitions, the set of mounting members being constructed and arranged to be secured to the vehicular robot.

Such techniques further involve connecting the assembly to a nozzle of the vehicular robot. The nozzle is constructed and arranged to spray foam concentrate from the foam assembly and water onto a target area. Such techniques further involve filling at least a portion of the chamber defined by the set of metal partitions with foam concentrate.

### CROSS REFERENCE TO RELATED APPLICATIONS

This application is a regular utility application based on earlier-filed U.S. Application No. 63/598,648 filed on Nov. 14, 2023, entitled “Delivering Foam Concentrate Via a Tank that Mounts to a Vehicular Robot”, the contents and teachings of which are hereby incorporated by reference in their entirety.

### BACKGROUND

A fire fighting vehicle which is robotically driven may be used in dangerous situations rather than risk human injury/life. For example, the nozzle end of a firehose may be attached to such a vehicle to enable the vehicle to apply water to an unsafe structure such as a burning object. Additionally, the hose from a foam supply truck may be concurrently connected to the vehicle to enable the vehicle to apply water and/or foam to the unsafe structure.

During operation, a human operator remotely controls the vehicle from a safe distance. In particular, while one or more hoses is/are connected to the vehicle, the human operator may robotically drive the vehicle within spraying distance of the unsafe structure and deliver spray from the nozzle onto the unsafe structure.

### SUMMARY

Improved techniques involve utilizing a foam concentrate tank assembly that mounts to a vehicular robot. While the tank assembly is mounted to the vehicular robot, the tank assembly may receive foam concentrate and then carry the foam concentrate while the vehicular robot is remotely guided toward a target area (e.g., a burning object or similar unsafe structure). Accordingly, there is no need for a hose to be connected between the vehicular robot and a foam supply truck while the vehicular robot is remotely guided or while the vehicular robot delivers foam onto a targeted area. That is, the range of the vehicular robot and/or the ability of the vehicular robot to maneuver is not restricted by any foam supply hose connected to a foam supply truck thus improving the ability of the vehicular robot to approach and address the target area (e.g., the vehicular robot may move closer to and/or maneuver among different locations around the target area to spray foam without needing to move any foam supply truck or negotiate with any hose connected to such a foam supply truck).

One embodiment is directed to a method of provisioning a vehicular robot with foam concentrate. The method includes mounting a foam concentrate tank assembly to the vehicular robot. The foam concentrate tank assembly includes:
(i) a set of metal partitions defining a chamber to hold foam concentrate,
(ii) a set of baffles disposed within the chamber and coupled with the set of metal partitions, and
(iii) a set of mounting members external to the chamber and coupled with the set of metal partitions, the set of mounting members being constructed and arranged to be secured to the vehicular robot.

The method further includes connecting the foam concentrate tank assembly to a nozzle of the vehicular robot. The nozzle is constructed and arranged to spray a mixture of foam concentrate from the foam concentrate tank assembly and water onto a target area. The method further includes filling at least a portion of the chamber defined by the set of metal partitions with foam concentrate.

Another embodiment is directed to a robotic foam delivery system which includes a vehicular robot, a foam concentrate tank assembly, and hardware which mounts the foam concentrate tank assembly to the vehicular robot. The foam concentrate tank assembly includes:
(i) a set of metal partitions defining a chamber to hold foam concentrate,
(ii) a set of baffles disposed within the chamber and coupled with the set of metal partitions, and
(iii) a set of mounting members external to the chamber and coupled with the set of metal partitions, the set of mounting members being constructed and arranged to be secured to the vehicular robot by the hardware.

Yet another embodiment is directed to a foam concentrate tank assembly to mount to a vehicular robot. The foam concentrate tank assembly includes a set of metal partitions defining a chamber to hold foam concentrate. The foam concentrate tank assembly further includes a set of baffles disposed within the chamber and coupled with the set of metal partitions. The foam concentrate tank assembly further includes a set of mounting members external to the chamber and coupled with the set of metal partitions, the set of mounting members being constructed and arranged to be secured to the vehicular robot.

In some arrangements, the foam concentrate tank assembly further includes an output port coupled with the set of metal partitions. The output port is constructed and arranged to output foam concentrate from the chamber.

In some arrangements, the set of metal partitions includes a front partition that defines a front of the foam concentrate tank assembly, and a rear partition that defines a rear of the foam concentrate tank assembly. The set of metal partitions further includes a bottom partition having a sloped bottom section which slopes from the rear partition toward the front partition.

In some arrangements, the set of mounting members is constructed and arranged to orient the front partition adjacent to a front of the vehicular robot and the rear partition adjacent to a rear of the vehicular robot. Additionally, the output port is disposed on the front partition adjacent to the front of the vehicular robot.

In some arrangements, the bottom partition further has a sump section adjacent the output port. The sloped bottom section pitches (or slopes) towards the sump section to collect foam concentrate within the chamber over the sump section and at (or in front of) the output port.

In some arrangements, the set of metal partitions further includes a set of side partitions that defines a set of sides of the foam concentrate tank assembly. Additionally, the set of baffles includes a set of transverse baffles coupled with the set of side partitions that defines the set of sides of the foam concentrate tank assembly.

In some arrangements, the set of baffles further includes at least one lateral baffle coupled with the front partition, the rear partition, and the set of transverse baffles. In some arrangements, the set of baffles includes multiple lateral baffles.

In some arrangements, the set of baffles includes multiple baffle members which define openings and which extend vertically within the chamber. The multiple baffle members are constructed and arranged to reduce foam concentrate movement within the chamber while also allowing foam concentrate to drain evenly within the chamber toward the output port.

In some arrangements, the multiple baffle members are metallic and welded to the set of metal partitions defining the chamber. For example, the set of metal partitions and/or baffle members may be formed of stainless steel.

In some arrangements, the set of metal partitions further includes side partitions coupled with the front partition and the rear partition, and a top partition coupled with the front partition, the rear partition, and the side partitions. Additionally, the foam concentrate tank assembly further includes an input port disposed on the top portion, the input port being constructed and arranged to input foam concentration into the chamber.

In some arrangements, the input port defines a first diameter. Additionally, the output port defines a second diameter. Furthermore, the first diameter is wider than the second diameter.

In some arrangements, the foam concentrate tank assembly further includes a set of vents disposed on the top portion. The set of vents (i.e., one or more vents) is constructed and arranged to allow air to enter the chamber to displace foam concentrate that leaves the chamber through the output port.

In some arrangements, the foam concentrate tank assembly further includes a control valve coupled with the output port. The control valve is constructed and arranged to control flow of foam concentrate through the output port.

In some arrangements, the control valve includes a mechanical handle which transitions the control value between an opened state that allows foam concentrate to flow through the output port and a closed state that prevents foam concentrate from flowing through the output port.

In some arrangements, the control valve includes an electrical interface constructed and arranged to couple with an electronic controller of the vehicular robot to enable an operator of the vehicular robot to remotely control foam concentrate flow through the output port.

In some arrangements, the foam concentrate tank assembly further includes a flush port constructed and arranged to drain the foam concentrate tank assembly. The flush port and the output port are disposed side-by-side along a bottom edge of the front partition with the output port being closer to a center of the vehicular robot and the flush port being further from the center of the vehicular robot when the foam concentrate tank assembly is mounted to the vehicular robot.

In some arrangements, the foam concentrate tank assembly further includes a suction hose constructed and arranged to convey foam concentrate from the output port to a nozzle of the vehicular robot via suction from the nozzle.

In some arrangements, the set of metal partitions further includes an inner side partition coupled with the front partition and the rear partition, an outer side partition coupled with the front partition and the rear partition. The inner side partition is closer to a center of the vehicular robot than the outer side partition. Additionally, the set of metal partitions further includes a top partition coupled with the front partition, the rear partition, and the side partitions. Furthermore, the foam concentrate tank assembly further includes an insulative ceramic layer (i) covering the front partition, the rear partition, the outer side partition, and the top partition and (ii) not covering the inner side partition and the bottom partition.

Other embodiments are directed to apparatus, devices, subsystems, and so on. Some embodiments are directed to various methods or processes, systems, and componentry which are involved in delivering foam concentrate via a tank that mounts to a vehicular robot.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of a robotic foam delivery system in accordance with certain embodiments.

FIG. 2 is a perspective view of a foam concentrate tank assembly in accordance with certain embodiments.

FIG. 3 is another perspective view of the foam concentrate tank assembly in accordance with certain embodiments.

FIG. 4 is side view of the foam concentrate tank assembly in accordance with certain embodiments.

FIG. 5 is another side view of the foam concentrate tank assembly in accordance with certain embodiments.

FIG. 6 is a top view of the foam concentrate tank assembly in accordance with certain embodiments.

FIG. 7 is a bottom view of the foam concentrate tank assembly in accordance with certain embodiments.

FIG. 8 is a front view of the foam concentrate tank assembly in accordance with certain embodiments.

FIG. 9 is a rear view of the foam concentrate tank assembly in accordance with certain embodiments.

FIG. 10 is a first cutaway view of the foam concentrate tank assembly in accordance with certain embodiments.

FIG. 11 is another cutaway view of the foam concentrate tank assembly in accordance with certain embodiments.

FIG. 12 is yet another cutaway view of the foam concentrate tank assembly in accordance with certain embodiments.

FIG. 13 is yet another cutaway view of the foam concentrate tank assembly in accordance with certain embodiments.

FIG. 14 is another perspective view of the robotic foam delivery system in accordance with certain embodiments.

FIG. 15 is a front view of the foam concentrate tank assembly mounted on a vehicular robot in accordance with certain embodiments.

FIG. 16 is a top view of the foam concentrate tank assembly mounted on the vehicular robot in accordance with certain embodiments.

FIG. 17 is a flowchart of a procedure for provisioning a vehicular robot with foam concentrate in accordance with certain embodiments.

### DETAILED DESCRIPTION

An improved technique involves utilizing a foam concentrate tank assembly that mounts to a vehicular robot such as a fire fighting vehicle which is robotically driven. While the tank assembly is mounted to the vehicular robot, the tank assembly may receive foam concentrate and then carry the foam concentrate while the vehicular robot is remotely guided toward a target area (e.g., a burning object, a burning building, etc.). Accordingly, there is no need for a hose to be connected between the vehicular robot and a foam supply truck while the vehicular robot is remotely guided or while the vehicular robot delivers foam to a targeted area. As a result, the range of the vehicular robot and/or the ability of the vehicular robot to maneuver is not restricted by any foam supply hose connected to a foam supply truck thus improving the ability of the vehicular robot to approach and address the target area (e.g., the vehicular robot may advance closer to and/or maneuver in a less hindered manner among different locations around the target area).

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

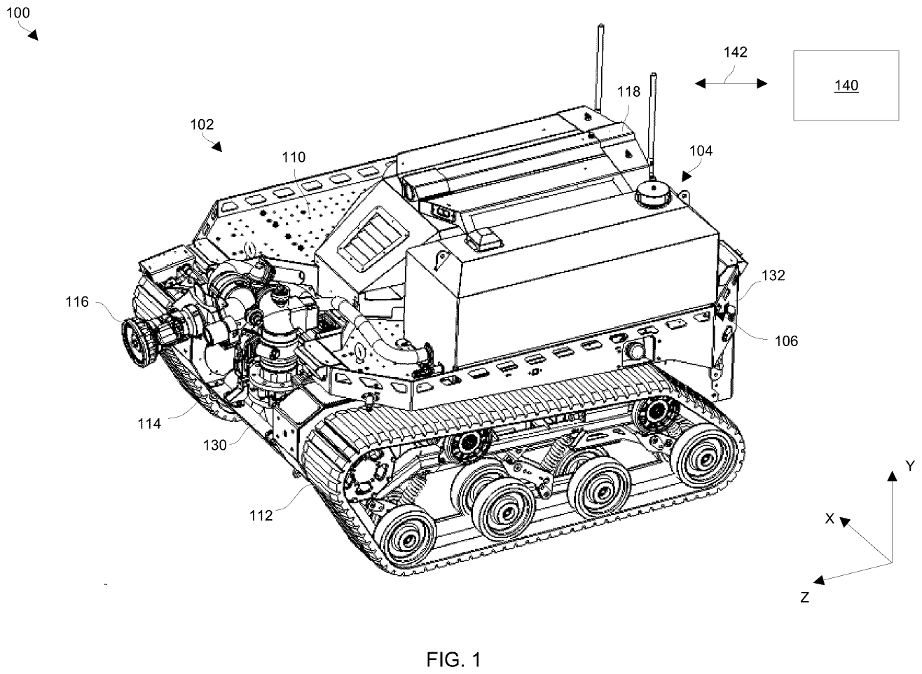

FIG. 1 shows a robotic foam delivery system 100 in accordance with certain embodiments. The robotic foam delivery system 100 includes a vehicular robot 102, a foam concentrate tank assembly 104, and hardware 106.

The vehicular robot 102 includes a body 110 (e.g., a chassis, a frame, etc.), a set of engagement members 112, a propulsion system 114, specialized equipment 116, and a controller 118. It should be understood that the vehicular robot 102 has the form factor of a robotic tracked fire fighting vehicle by way of example only and that other types of form factors are suitable for use as well such as a quad-style all-terrain vehicle with a set of protective screens, a crane with a set of protective screens, construction equipment, military equipment, other specialized movable equipment, amphibious craft, watercraft, other hybrid craft, and so on which may utilize foam concentrate from a tank.

The body 110 defines a front 130 and a back 132. Accordingly, when the vehicular robot 102 moves forward, the vehicular robot 102 is considered to move in a front-to-back direction (i.e., the positive Z-direction in FIG. 1).

Additionally, the body 110 may offer various mounting locations (e.g., decking areas) that enable equipment such as the foam concentrate tank assembly 104 to be conveniently mounted and accessed. In some arrangements, decking areas of the body 110 horizontally extend over respective engagement members 112 thus providing a platform for equipment as well as protection/shielding to the engagement members 112.

The set of engagement members 112 is constructed and arranged to interact with the environment to move the vehicular robot 102. It should be understood that various types of engagement members 104 are suitable for use (e.g., tracks, tires/wheels, propellers, fans, combinations thereof, and so on) depending on the type of environment or terrain (e.g., a road, dirt, brush, snow, ice, marsh, water, etc.).

The propulsion system 114 is constructed and arranged to control vehicle movement such as drive provided by the set of engagement members 104, speed control, braking, and so on thus enabling the vehicular robot 102 to effectively maneuver and perform useful work. Along these lines, the propulsion system 114 enables the vehicular robot 102 to move forward, backward, turn, and so on.

The specialized equipment 116 is constructed and arranged to perform useful work. In the context of a fire fighting vehicle, the specialized equipment 116 may include a monitor (or nozzle) assembly capable of spraying foam toward a targeted area. In some arrangements, the monitor assembly performs foam concentrate induction and includes a mixer that combines foam concentrate from the foam concentrate tank assembly 104 and water (e.g., supplied via a set of hoses) to generate the foam prior to outputting the foam toward the targeted area in high volume (e.g., at a rate of 2500+/−gallons per minute).

The controller 118 is constructed and arranged to operate various componentry of the vehicular robot 102 such as the propulsion system 114 and/or the specialized equipment 116. In the context of the fire fighting vehicle, the controller 118 may aim or point a nozzle/head of the monitor assembly (e.g., via a set of actuators), operate fluid valves, etc. to generate foam and spray the foam at a targeted area. Additionally, the controller 118 may obtain information from the surrounding environment, manage other resources and/or operate other equipment, lift, push, communicate with a base station via a wireless data communications device 134, and so on.

The foam concentrate tank assembly 104 is constructed and arranged to hold foam concentrate while mounted on the vehicular robot 102. As will be explained in further detail shortly, the foam concentrate tank assembly 104 alleviates the need to hook up the vehicular robot 102 to a foam supply truck. Accordingly, the vehicular robot 102 is freer to maneuver towards and/or around a targeted area to spray foam.

The hardware 106 is constructed and arranged to mount the foam concentrate tank assembly 104 to the body 110 of the vehicular robot 102. In some arrangements, the hardware 106 includes bolts and/or similar types of fasteners. In some arrangements, the hardware 106 includes clamps, latches, combinations thereof, etc. to enable quicker/simpler mounting of the foam concentrate tank assembly 104 onto and/or dismounting of the foam concentrate tank assembly 104 from the vehicular robot 102 (e.g., to enable the foam concentrate tank assembly 104 to be exchanged with other equipment).

Certain componentry such as the hardware 106, the propulsion system 114, the controller 118, etc. are represented by various corresponding reference numerals in FIG. 1. However, it should be appreciated that some of this componentry may be housed within other componentry and/or somewhat blocked from view by other componentry in FIG. 1.

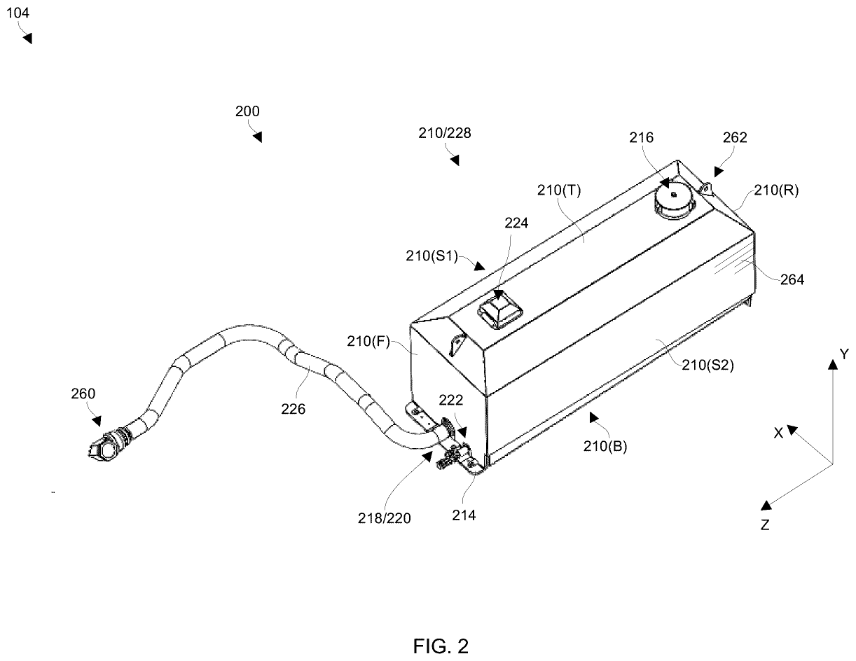

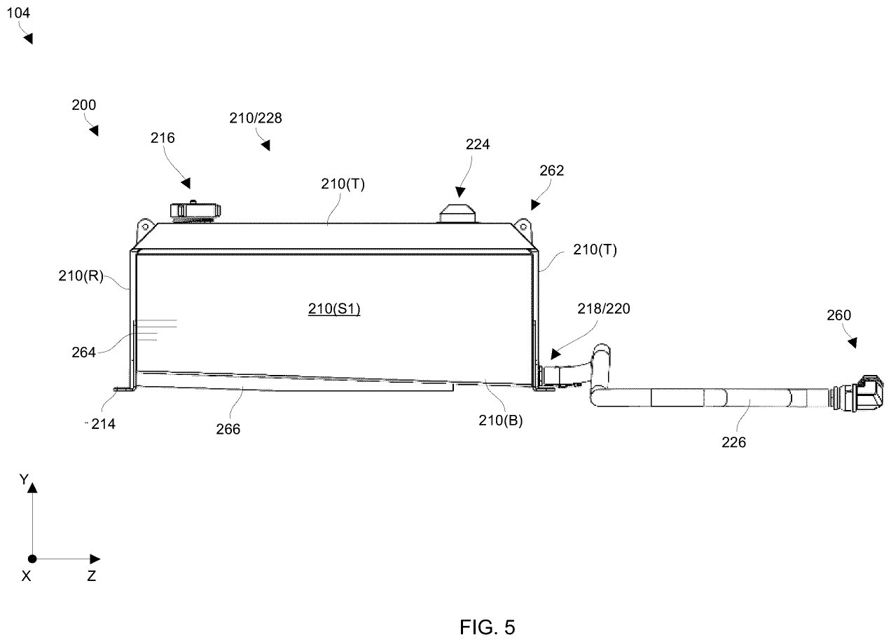

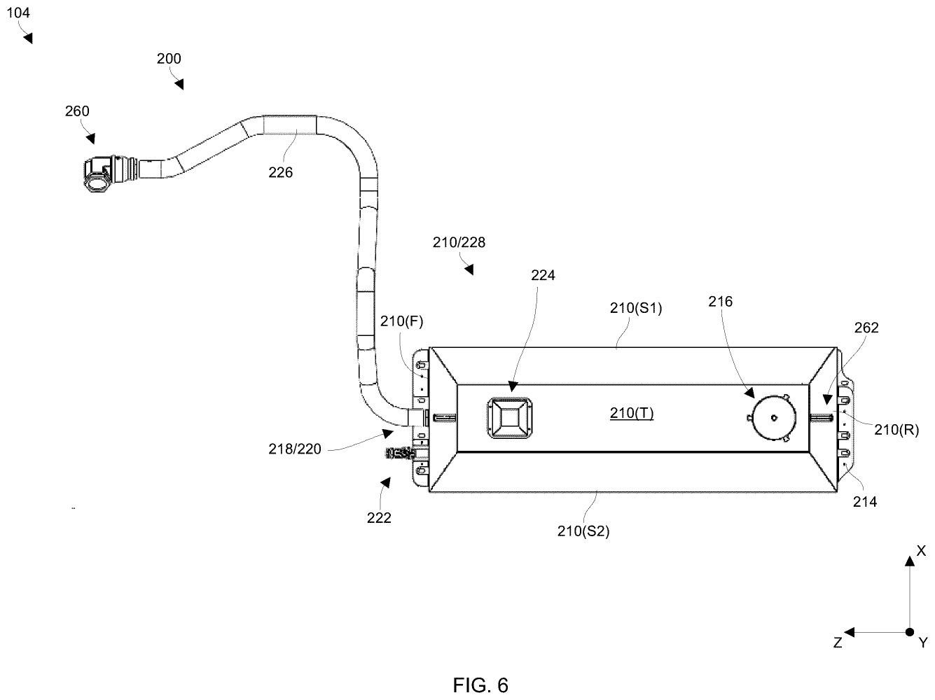

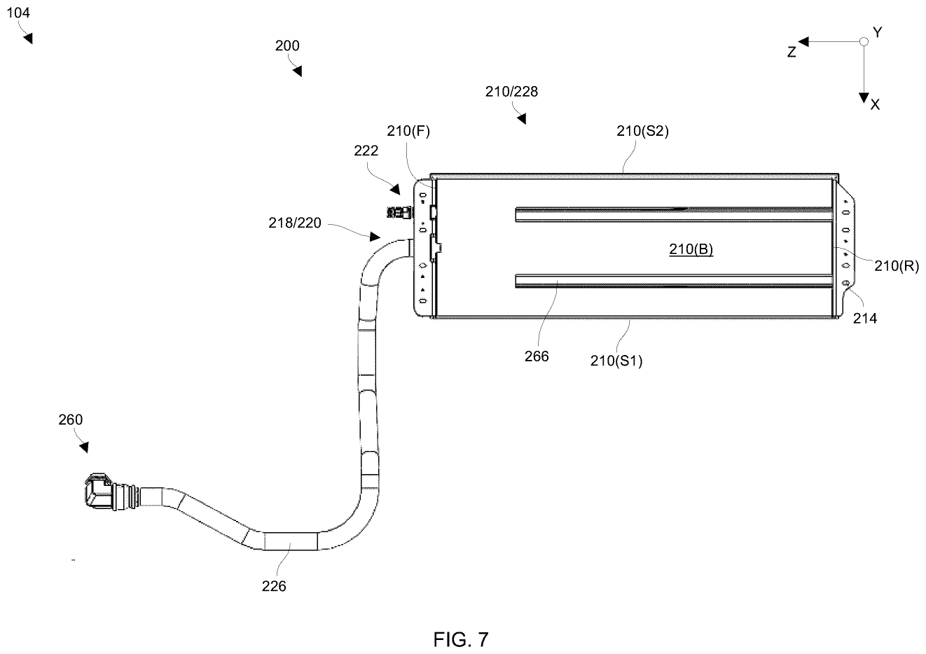

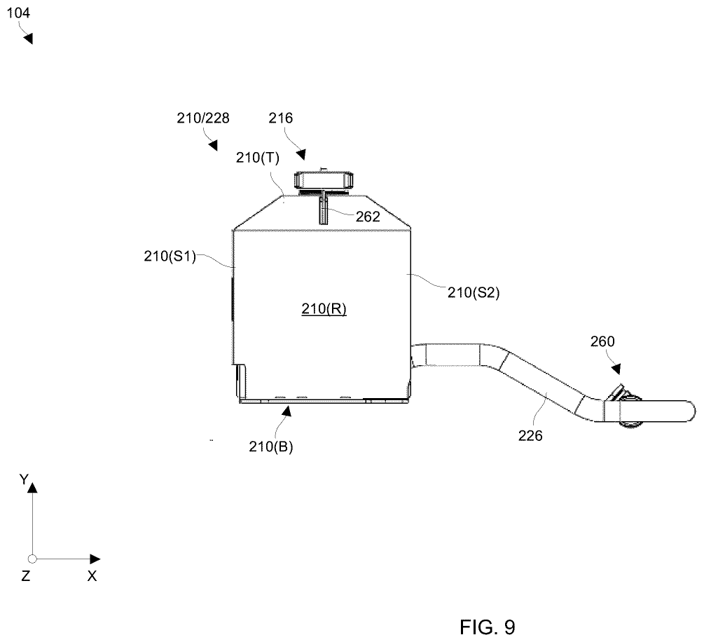

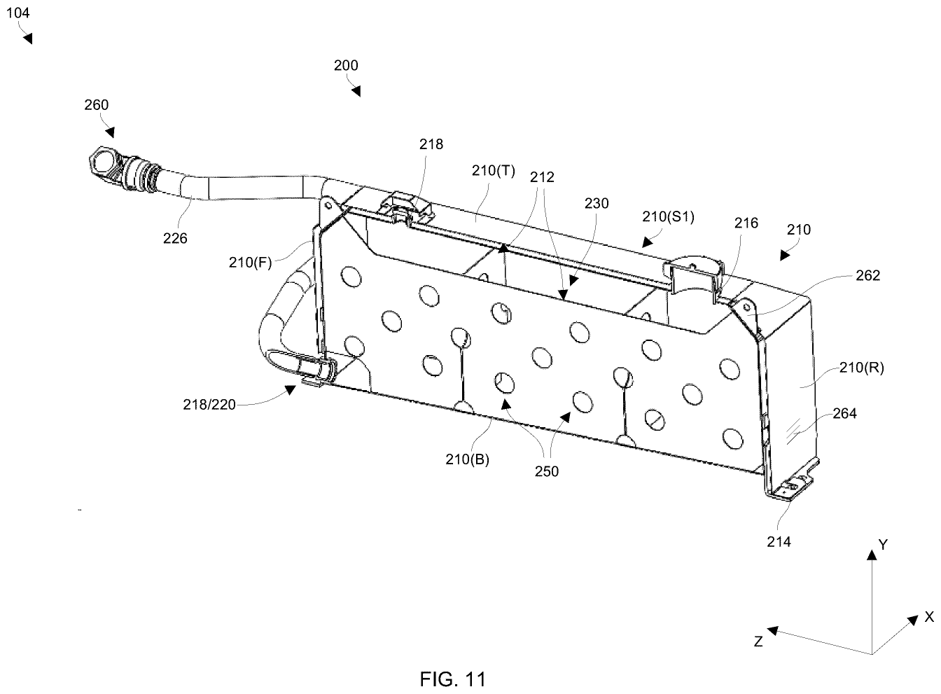

During operation, the vehicular robot 102 communicates with a remote device 140 to perform a variety of tasks. Along these lines, the vehicular robot 102 and the remote device 140 may communicate via wireless signals 142. Such tasks may include sensing a targeted area (e.g., for heat, people, danger, etc.), moving from one location to another, and spraying water and/or foam at the targeted area. That is, a human user operating the remote device 140 may receive information from the vehicular robot 102 and/or remotely control various operations of the robotic foam delivery system 100 from a safe distance. In some arrangements, the remote device 140 may provide the user with a graphical user interface and control logic to enable the user to reliably and robustly utilize the vehicular robot 102 from the remote device 140. Further details will now be provided with reference to FIGS. 2 through 13.

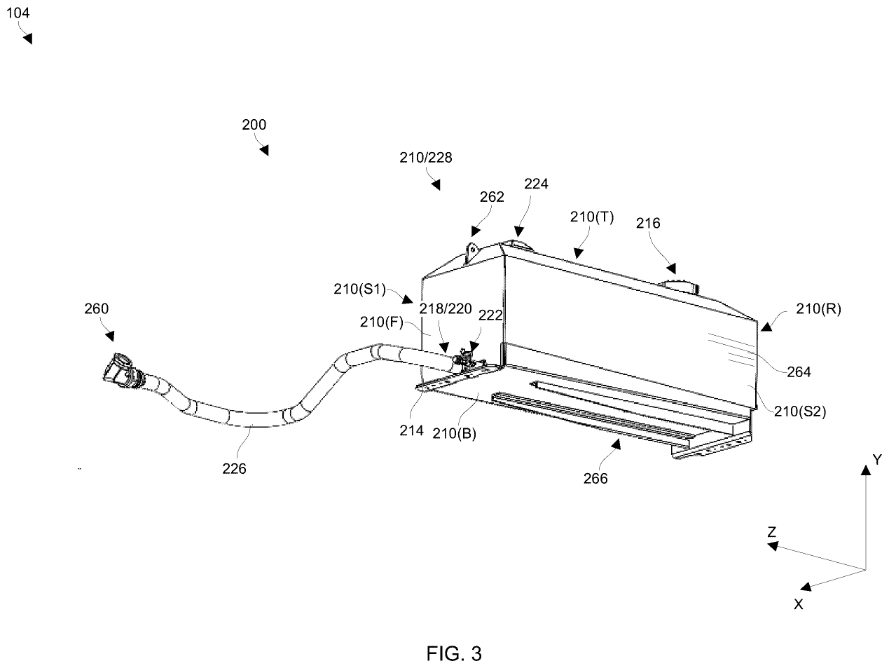

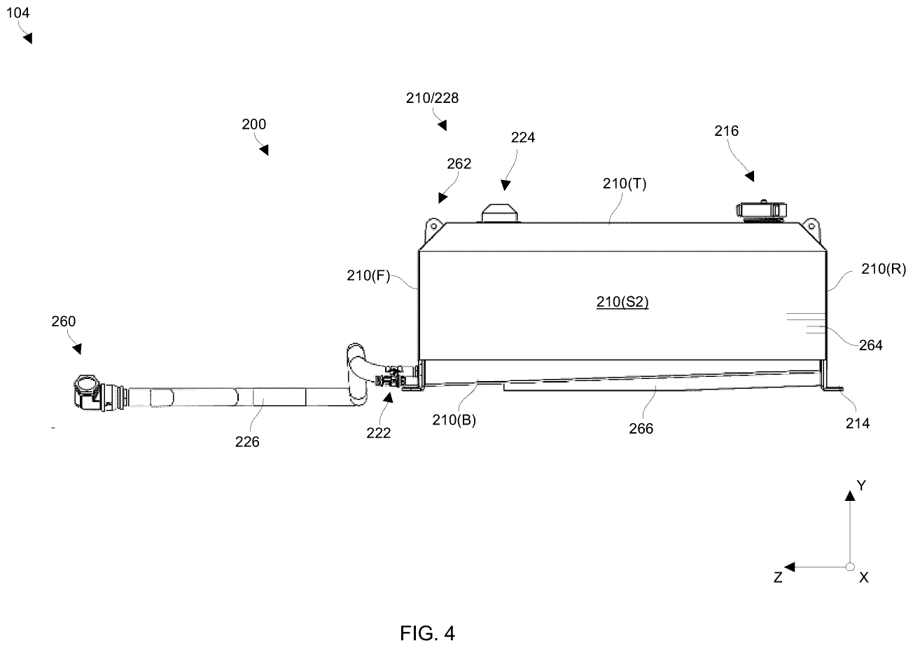

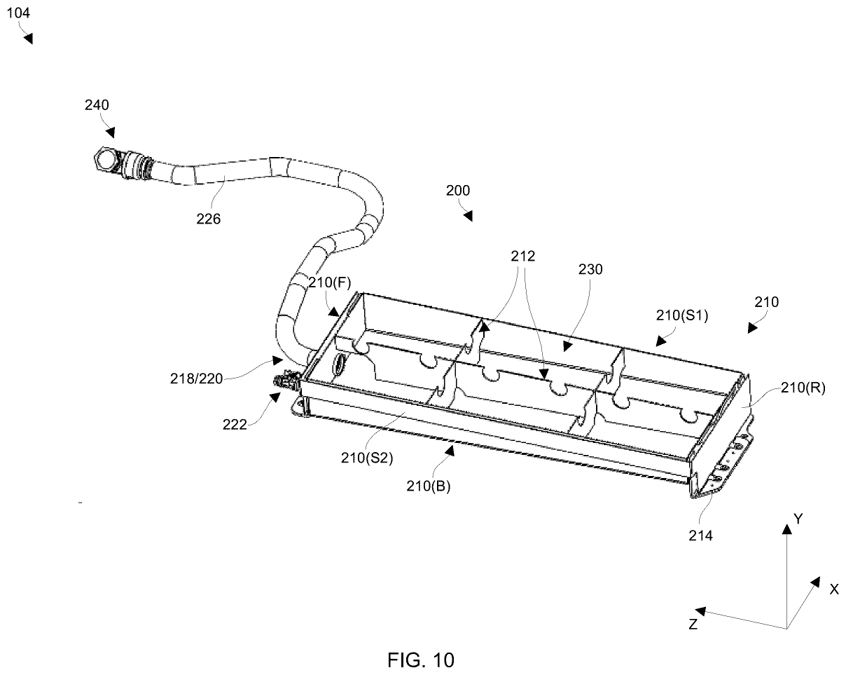

FIGS. 2 through 13 show certain details of the foam concentrate tank assembly 104 in accordance with certain embodiments. FIGS. 2 and 3 are perspective views of the foam concentrate tank assembly 104 from different angles. FIGS. 4 through 9 are various other external views of the foam concentrate tank assembly 104 from different angles. FIGS. 10 through 13 are various cutaway views of the foam concentrate tank assembly 104.

As shown in FIGS. 2 through 13, the foam concentrate tank assembly 104 includes various componentry 200 such as a set of metal partitions (or walls) 210, a set of baffles 212, a set of mounting members 214, an input port 216, an output port 218, a control valve 220, a flush port 222, a set of vents 224, and a hose 226.

The set of metal partitions 210 includes a front partition 210(F), a rear partition 210(R), side partitions 210(S1), 210(S2), a top partition 210(T), and a bottom partition 210(B) configured to form or define a rigid tank 228. In some arrangements, the set of metal partitions 210 is formed of stainless steel (e.g., sheet stock which is bent, cut, welded, etc.).

The front partition 210(F) defines a front of the foam concentrate tank assembly 104. Along these lines, the front partition 210(F) is adjacent the front 130 of the vehicular robot 102 and faces forward (i.e., the positive Z-direction) when the foam concentrate tank assembly 104 is properly mounted to the body 110 of the vehicular robot 102 (also see FIG. 1).

Similarly, the rear partition 210(R) defines a rear of the foam concentrate tank assembly 104. That is, the rear partition 210(R) is adjacent the rear 132 of the vehicular robot 102 and faces rearward (i.e., the negative Z-direction) when the foam concentrate tank assembly 104 is properly mounted to the body 110 of the vehicular robot 102.

Additionally, when the foam concentrate tank assembly 104 is properly mounted to the body 110 of the vehicular robot 102, the bottom partition 210(B) forms the underside of the foam concentrate tank assembly 104 and faces downward (i.e., the negative Y-direction) toward the body 110. Furthermore, the top partition 210(T) forms the top of the foam concentrate tank assembly 104 and faces upward (i.e., the positive Y-direction) away from the body 110. Also, an inner side partition 210(S1) is closest to the centerline (or simply center of the vehicular robot 102), and an outer side partition 210(S2) is furthest from the center of the vehicular robot 102.

As best seen in the cutaway views of FIGS. 10 through 13, the set of metal partitions 210 defines a chamber 230 to hold foam concentrate and the set of baffles 212. In some arrangements, the chamber 230 is elongated (e.g., longer along the Z-axis) and advantageously sits over a similarly elongated section of the body 110 of the vehicular robot 102. Such an arrangement enables the foam concentrate tank assembly 104 to derive beneficial support from the vehicular robot 102.

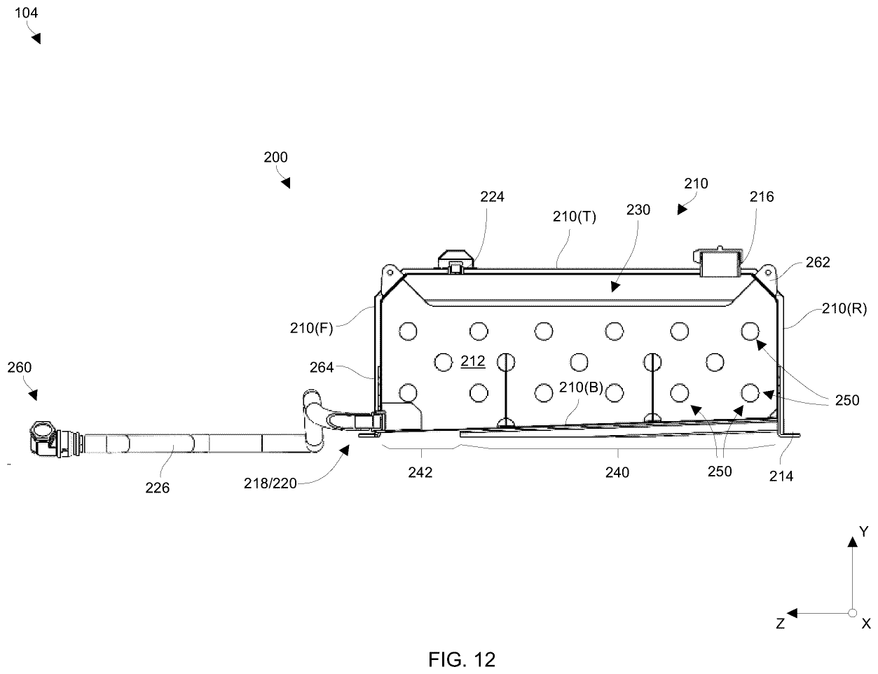

In some arrangements, the bottom partition 210(B) includes a pitched section 240 which shares a bottom edge with the rear partition 210(R), and a sump section 242 which shares a bottom edge with the front partition 210(F) (see FIG. 12). The pitched section 240 is higher nearer the rear partition 210(R) and slopes downward (i.e., in the negative Y-direction) towards the front partition 210(F) to the sump section 242 thus enabling foam concentrate to flow forward in the positive Z-direction and collect over the sump section 242.

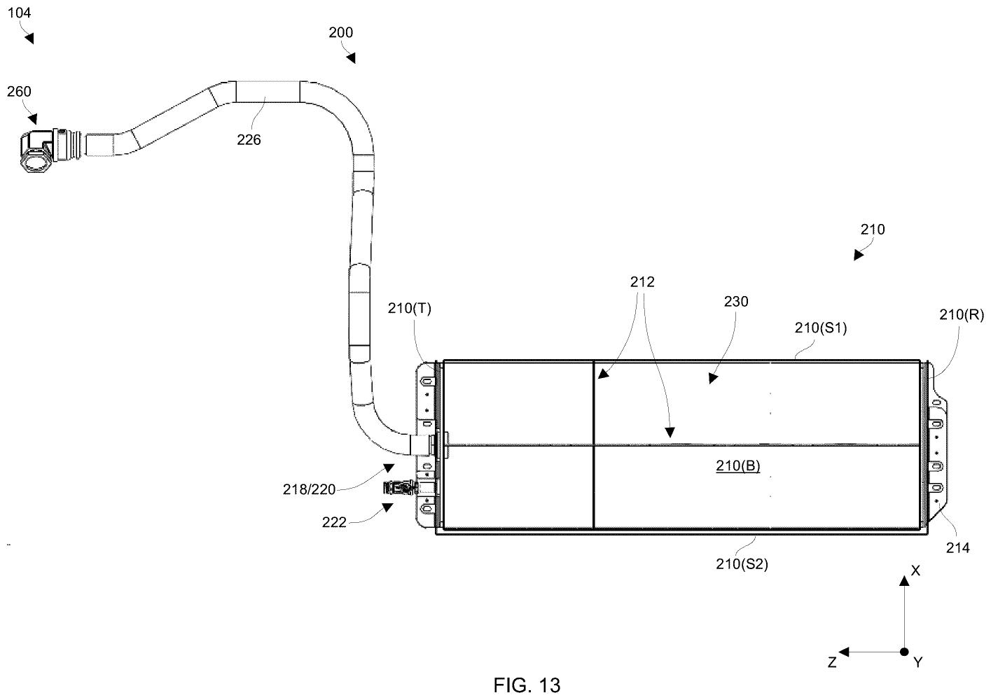

The set of baffles 212 is constructed and arranged to reside within the chamber 230 and reduce movement of foam concentrate (i.e., fluid movement) held in the chamber 230 while the vehicular robot 102 is moving (e.g., see FIGS. 10 through 13). Additionally, the set of baffles 212 provides support for various partitions 210 to provide strength and assist in maintaining tank structure. Along these lines, there is at least one transverse baffle 212 (e.g., one, two, three, etc.) vertically extending in the X-Y plane between the side partitions 210(S1), 210(S2). Additionally, there is at least one lateral baffle 212 (e.g., one, two, etc.) vertically extending the Y-Z plane between the front and rear partitions 210(F), 210(R). In some arrangements, the transverse and lateral baffles 212 are perpendicular to each other (e.g., see FIG. 13 which shows a transverse baffle and lateral baffle intersecting each other). In some arrangements, all of the baffles 212 couple with the bottom partition 210(B). In some arrangements, the baffles 212 are made of the same material as the partitions 210 (e.g., stainless steel).

In some arrangements, the set of baffles 212 fasten or attach to each other and/or to the set of partitions 210. Such fastening may be via welds, slotted engagement, combinations thereof, etc.

In some arrangements, one or more of the baffles 212 defines openings 250 through which fluid may flow (e.g., see FIGS. 10 through 12). At least some of the openings 250 are along the bottom partition 210(B). Accordingly, foam concentrate is able to drain evenly within the chamber 230 down and toward the sump section 242 (FIG. 12).

The set of mounting members 214 couples with the set of partitions and is constructed and arranged to be secured to the vehicular robot 102. In some arrangements, the set of mounting members 214 includes a first foot coupled with the front partition 210(F) and a second foot coupled with the rear partition 210(R) to support the bottom partition 210(B) over the body 110 of the vehicular robot 102. In some arrangements, the set of mounting members 214 defines mounting holes to enable the hardware 106 (e.g., bolts, etc.) to secure the foam concentrate tank assembly 104 to the vehicular robot 102.

The input port 216 is disposed on the top partition 210(T) and is constructed and arranged to allow foam concentrate to enter the chamber 230 through the top partition 210(T). The input port 216 may define a lip or other shape (e.g., a funnel) to facilitate certain operations such as supporting a cover (or cap), enabling the cover to thread onto and/or from the input port 216, directing flow into the chamber 230, and so on.

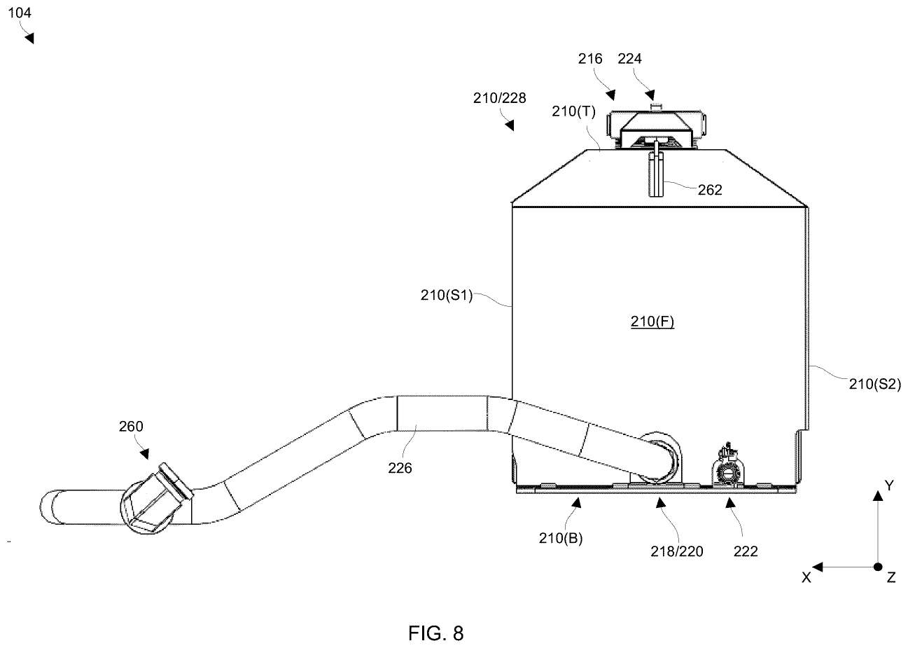

The output port 218 is disposed on the front partition 210(F) and is constructed and arranged to allow foam concentrate to exit the chamber 230 through the front partition 210(F). The output port 218 may define a lip or other shape to facilitate certain operations such as supporting a control valve, coupling with a hose, and so on. In some arrangements, the output port 218 is adjacent the sump section 242 of the bottom partition 210(B) (e.g., see FIG. 8) enabling foam concentrate that collects over the sump section 242 to easily reach the output port 218.

It should be understood that the output port 218 may be disposed at other locations of the foam concentrate tank assembly 104. For example, a suitable alternative location for the output port 218 is in the sump area 242 of the bottom partition 210(B).

In some arrangements, the input port defines a diameter which is wider than that of the output port 218. Such a feature enables quicker filling of the chamber 230 with foam concentrate (e.g., via a bucket, hose, or other supply mechanism). Additionally, the narrower output port 218 provides for effective withdrawal of foam concentrate from the chamber 230 (e.g., assisted by siphoning provided from the specialized equipment 116 of the vehicular robot 102 such as a monitor assembly, also see FIG. 1).

The control valve 220 couples with the hose 226 and is constructed and arranged to control the flow of foam concentrate from the chamber 230 for use by the specialized equipment 116 (also see FIG. 1). For example, in the context of a fire fighting vehicle, the control valve 220 may remain closed while the fire fighting vehicle moves toward a burning object or structure. The control valve 220 may then open to allow foam concentrate to exit from out of the chamber 230 to a monitor assembly for foam spraying onto the burning object or structure. It should be understood that the control valve 220 may be located between the output port 218 and the hose 226. Alternatively, the control valve 220 may be located at an opposite end of the hose 226 or even along the hose 226.

In some arrangements, the control valve 220 includes a handle which enables a human user to manually open and close the control valve 220. In other arrangements, the control valve 220 includes an electric actuator which enables the control valve 220 to open and close via remote control (e.g., electrical signals sent from the controller 118 of the vehicular robot 102, also see FIG. 1). In yet other arrangements, the control valve 220 includes both a handle and electric actuator to enable manual and/or remote control.

The flush port 222 is disposed on the front partition 210(F) and is constructed and arranged to enable convenient cleaning of the chamber 230. The flush port 222 may define a lip or other shape to facilitate certain operations such as attachment of a water hose, etc.

In some arrangements, the flush port 222 is adjacent the sump section 242 of the bottom partition 210(B) and the output port 218 with the output port 218 being closer to the center of the vehicular robot 102 (e.g., see FIGS. 1, 8 and 13). Such arrangements shorten the flow path through the hose 226 from the chamber 230 to the specialized equipment 116 of the vehicular robot 120 (e.g., a monitor assembly of a fire fighting vehicle), and enables easy/convenient flushing access (e.g., for attachment of a water hose, for draining out the chamber 230, etc.) without interference from the hose 226.

The set of vents 224 is constructed and arranged to permit air to flow into the chamber 230 as foam concentrate exits the chamber 230 through the output port 218. Along these lines, the foam concentrate may be extracted from the chamber 230 via siphoning action, and air may enter the chamber 230 through the set of vents 224 to displace the removed foam concentrate. Accordingly, a vacuum is less likely to form within the chamber 230 that could otherwise hinder removal of the foam concentrate from the chamber 230 and perhaps result in tank deformation/damage.

As mentioned earlier, the set of baffles 212 provides structure to the partitions (or tank walls) 210. Accordingly, if the set of vents 224 fails partially or completely, the set of baffles 212 helps prevent the tank 228 from deforming inward. Likewise, when the tank 228 is full of fluid, the set of baffles 212 strengthens the partitions 210 so that the fluid does not push out and deform the partitions 210.

The hose 226 is constructed and arranged to convey foam concentrate from the chamber 230 to specialized equipment 116. The hose 226 has a length which is well suited to provide a healthy foam concentrate delivery path and which allows for the specialized equipment 116 to freely operate (e.g., which enables a monitor assembly to enjoy a maximum angular range in all directions). Furthermore, the hose 226 may have a geometry/structure (e.g., diameter, strength, etc.) that provides robust and reliable flow that is resistant to compressing, kinking, clogging, bottlenecking, melting, and so on.

In accordance with certain embodiments, the componentry 200 includes one or more additional features such as an interface 260, lift points 262, a ceramic layer 264, one or more additional positioning members 266, and so on. Other componentry 200 is suitable for use as well (e.g., sensors, meters, filters, etc.).

The interface 260 is constructed and arranged to attach the hose 226 to a connector or input of the specialized equipment 116 (e.g., an input of the monitor assembly), and may be angled (e.g., a 90 degree angle). The interface 260 may take the form of a clamp, a coupler, other type of connector, etc. Such an interface 260 enables healthy delivery of foam concentrate to the specialized equipment 116 without causing the hose 226 to interfere with the operation (e.g., angular mobility) of the specialized equipment 116.

The lift points 262 are constructed and arranged to enable easy lifting of the foam concentrate tank assembly 104 onto and/or off of the vehicular robot 102. In some arrangements, the lift points 262 include tabs with openings to enable lifting via various equipment (e.g., via a crane, a hoist/pulley, a jig, etc.). Such lift points 262 alleviate the need to carry the foam concentrate tank assembly 104 in a different manner or via other means. Although two lift points are provided by way of example, the foam concentrate tank assembly 104 may include a different number of lift points 262 (e.g., one, three, four, and so on).

The ceramic layer 264 is constructed and arranged to insulate the chamber 230 from excessive heat (e.g., when the foam concentrate tank assembly 104 is near a burning object). The ceramic layer 264 may reside as a cover or coating on the inside of the tank 228 (e.g., facing the chamber 230) or on the outside of the tank 228 (facing away from the chamber 230). In some arrangements, the ceramic layer is only on the front partition 210(F), the rear partition 210(R), the top partition 210(T) and the outer side partition 210 (S2) since the bottom partition 210(B) and the inner side partition 210 (S1) is able to receive heat shielding from the vehicular robot 102.

Alternatively, the ceramic layer 264 may be replaced or combined with blanketing material. Such material insulates the foam concentrate tank assembly 104 against damage, failure, and so on due to excessive heat, etc.

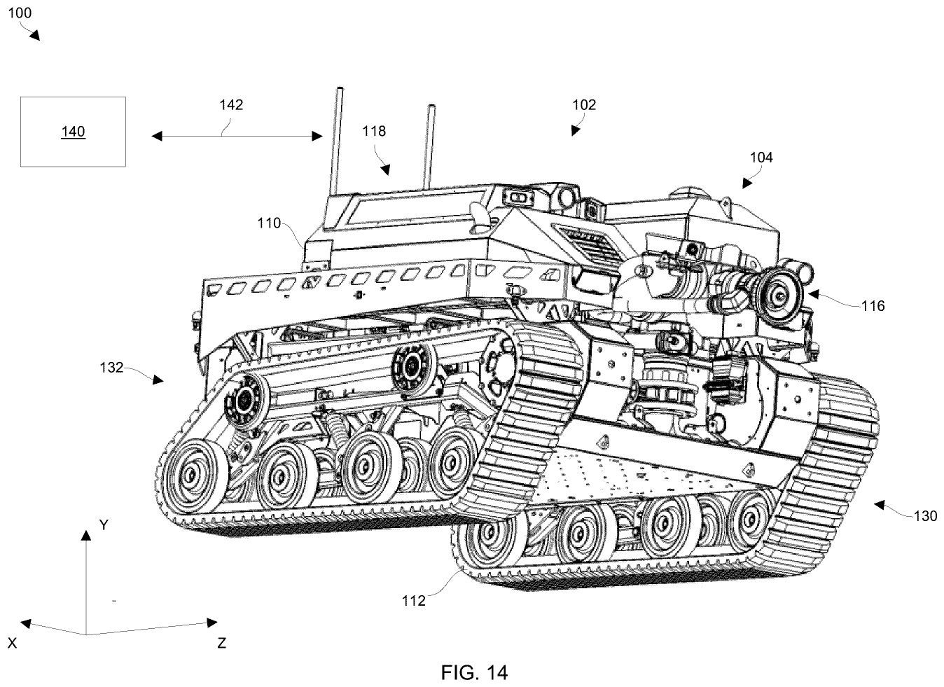

The one or more other additional positioning members 266 are constructed and arranged to further position the foam concentrate tank assembly 104 relative to the vehicular robot 102. Along these lines, the one or more other additional positioning members 266 includes a set of support beams (or feet) to support the bottom partition 210(B) over the body 110 of the vehicular robot 102 (e.g., see FIGS. 3 through 5). Such one or more positioning members 266 also prevent the bottom partition 210(B) from outwardly bowing and/or deforming when the tank 228 is filled with foam concentrate. Other types of positioning members are suitable for use as well (e.g., scaffolds, rails, welds, brackets, cross members, ribs, etc.). Further details will now be provided with reference to FIGS. 14 through 16.

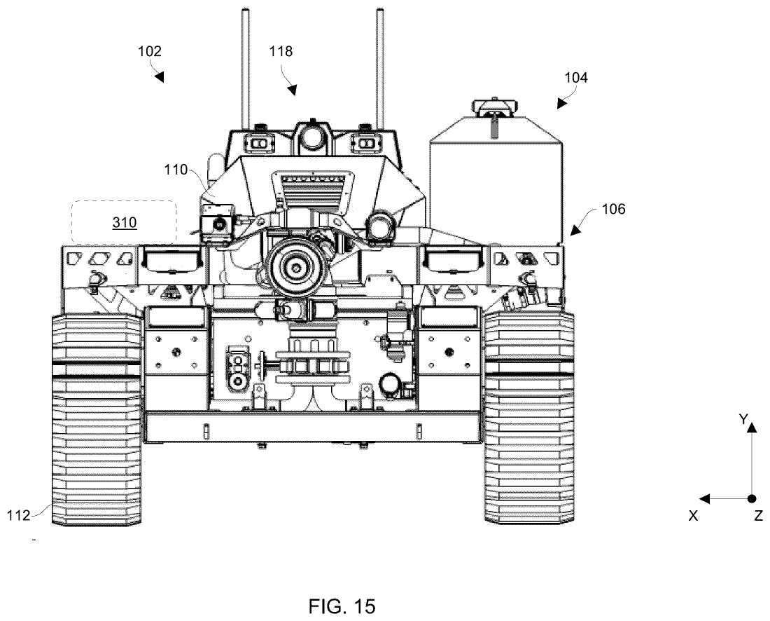

FIGS. 14 through 16 show further details for the relationship between the vehicular robot 102, in the example context of a fire fighting vehicle, and the foam concentrate tank assembly 104 in accordance with certain embodiments. FIG. 14 is another perspective view of the robotic foam delivery system 100 (also see FIG. 1). FIG. 15 is a front view of the vehicular robot 102 and the foam concentrate tank assembly 104 when the foam concentrate tank assembly 104 is mounted to the vehicular robot 102 via the hardware 106. FIG. 15 is a top view of the vehicular robot 102 and the foam concentrate tank assembly 104 when the foam concentrate tank assembly 104 is mounted to the vehicular robot 102 via the hardware 106.

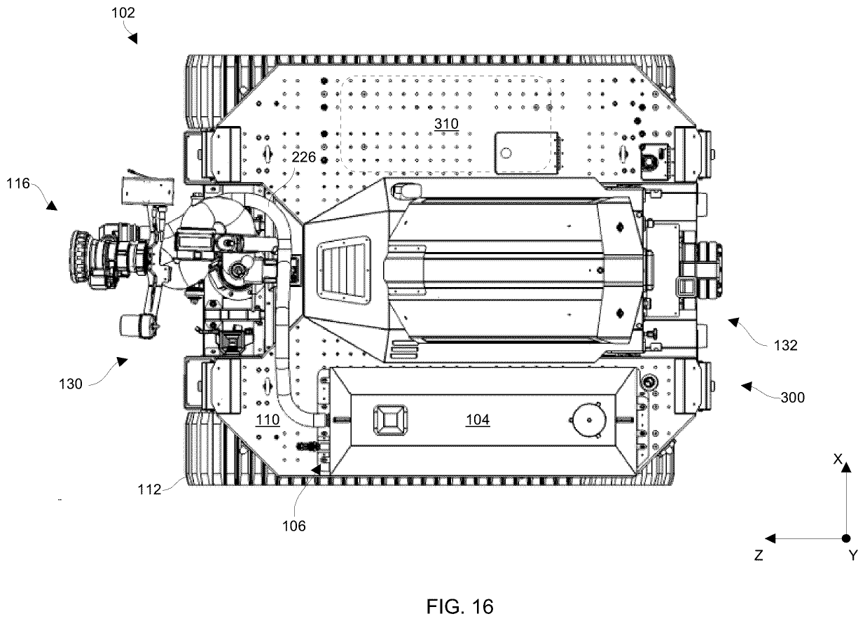

As easily seen in FIG. 16, the hose 226 of the foam concentrate tank assembly 104 may navigate to an input port of the specialized equipment 116 (e.g., a monitor assembly) residing at the front 130 of the vehicular robot 102. Such a feature enables the specialized equipment 116 to have maximum angular range (e.g., to aim spray at a target area from various angles) while robustly and reliably supplying foam concentrate to the specialized equipment 116.

Additionally, in some embodiments, the hose 226 remains relatively flush with the plane of the body 110. Such embodiments avoid excessive hose length and may streamline the flow path.

In some arrangements, the vehicular robot 102 is provisioned with back-to-front piping (or plumbing) 300 (FIG. 16) that connects to one or more water sources (e.g., via a set of intakes that connect to a set of hoses leading to a set of hydrants). Such piping 300 may extend from the back 132 through the body 110 to the front 130 of the vehicular robot 102 where the specialized equipment 116 is able to deliver water at a rate of 2500 gallons per minute or higher. In such a situation, the water is able to mix with foam concentrate from the foam concentrate tank assembly 104 to generate foam which is then sprayed at a target area from a nozzle or head.

It should be understood that nothing precludes the vehicular robot 102 from having the foam concentrate tank assembly 102 mounted to the opposite side of the vehicular robot 102. Along these lines, the body 110 of the vehicular robot 102 offers another space 310 on the opposite side (see FIGS. 15 and 16).

In some arrangements, the robotic foam delivery system 100 includes multiple foam concentrate tank assemblies 102 (e.g., foam concentrate tank assemblies 102 mounted on both sides of the body 110). Such arrangements offer greater foam concentrate capacity.

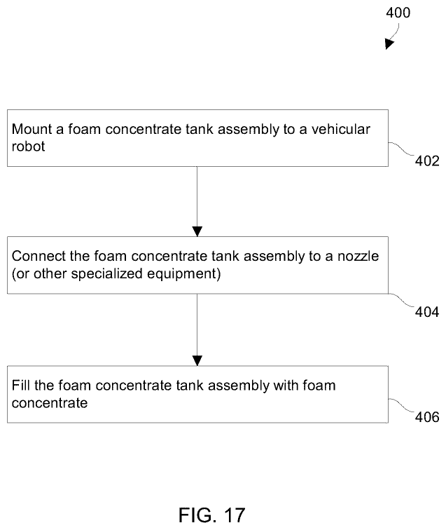

In some arrangements, one side of the body 110 (e.g., the space 310) is unoccupied by a foam concentrate tank assembly 104. Accordingly, the operator may utilize that side for carrying other things (e.g., hoses, supplies, sensing equipment, devices for deployment, other componentry, etc.). Further details will now be provided with reference to FIG. 17.

FIG. 17 is a flowchart of a procedure 400 for provisioning a vehicular robot with foam concentrate in accordance with certain embodiments. Such provisioning alleviates the need to connect the vehicular robot to a foam supply truck or trailing foam source which would other be cumbersome and hinder maneuverability of the vehicular robot.

At 402, a foam concentrate tank assembly is mounted to the vehicular robot. As explained earlier, in accordance with certain embodiments, the foam concentrate tank assembly includes:
(A) a set of metal partitions defining a chamber to hold foam concentrate,
(B) a set of baffles disposed within the chamber and coupled with the set of metal partitions, and
(C) a set of mounting members external to the chamber and coupled with the set of metal partitions, the set of mounting members being constructed and arranged to be secured to the vehicular robot when the foam concentrate tank assembly is mounted to the vehicular robot.

At 404, the foam concentrate tank assembly is connected to a nozzle (or monitor) of the vehicular robot (e.g., see the interface 260 in FIG. 2 and the hose 226 in FIG. 16).

The nozzle is constructed and arranged to spray foam concentrate from the foam concentrate tank assembly and water on a target area.

At 406, at least a portion of the chamber defined by the set of metal partitions is filled with foam concentrate. At this point, foam concentrate within the foam concentrate tank assembly available to the vehicular robot. In some arrangements, the foam concentrate tank assembly is provisioned with a valve that, when opened, allows the foam concentrate to flow from the foam concentrate tank assembly to the nozzle.

As described above, improved techniques involve utilizing a foam concentrate tank assembly 104 that mounts to a vehicular robot 102. While the tank assembly 104 is mounted to the vehicular robot 102, the tank assembly 104 may receive foam concentrate and then carry the foam concentrate while the vehicular robot 102 is remotely guided toward a target area (e.g., a burning object or similar unsafe structure). Accordingly, there is no need for a hose to be connected between the vehicular robot 102 and a foam supply truck while the vehicular robot 102 is remotely guided or while the vehicular robot 102 delivers foam onto a targeted area. That is, the range of the vehicular robot 102 and/or the ability of the vehicular robot 102 to maneuver is not restricted by any foam supply hose connected to a foam supply truck thus improving the ability of the vehicular robot 102 to approach and address the target area (e.g., the vehicular robot 102 may move closer to and/or maneuver among different locations around the target area to spray foam without needing to move any foam supply truck or negotiate with any hose connected to such a foam supply truck).

While various embodiments of the present disclosure have been particularly shown and described, it will be understood by those skilled in the art that various changes in form and details may be made therein without departing from the spirit and scope of the present disclosure as defined by the appended claims.

In accordance with certain embodiments, specialized equipment such as a foam induction monitor is able to obtain foam concentrate from a foam concentrate tank/delivery system. Such is well suited for fluid transportation/firefighting and, in particular, to robotic firefighting attachments.

Conventional approaches may only involve using a robot able to spray foam when the robot is hooked to a truck pumping foam. Unfortunately, such use of a truck to pump foam is a significant resource requirement and can impede operation of the robot.

However, with the improved techniques disclosed herein, a robot is able to use a foam induction tank to carry its own foam concentrate. Accordingly, the robot is now able to spray foam without a foam capable truck, a hydrant to feed foam, etc.

In accordance with certain embodiments, the tank is a 50 gallon tank that is capable of being mounted on multiple robot vehicle platforms (or other robot configurations). Other capacities such as those within a range of 30 gallons to 200 gallons are suitable as well (40 gallons, 60 gallons, 75 gallons, etc.).

The bottom surface of the tank features a slope that leads to the siphon port, ensuring full use of the foam concentrate. Internally the tank has baffles running fore and aft as well as side to side to help reduce fluid movement while the vehicle is moving. A large fill port on the top of the tank allows for easy fill from a 5 gallon pail of concentrate or a transfer pump from a larger drum.

In accordance with certain embodiments, a large vent on the top of the tank allows for sufficient airflow to prevent deformation or destruction of the tank when the concentrate is siphoned out. The siphon port has a valve (manual or electric) that allows for choosing to use foam or to not.

In some arrangements, utilizing mounting points on the vehicle fore and aft, the foam tank may be lowered onto a robot vehicle and secured via its two mounting feet. The fill cap is removed by operator and foam concentrate is poured into the tank via small pails of concentrate, or via a large drum, etc. Once filled the valve is either manually opened or if so equipped, it can be remotely opened/closed, and the robot is sent in to fight the fire.

From the valve, the concentrate flows down to the monitor via a suction hose and is induced into the water stream via a Venturi port that exists on the purchased monitor. The sloped floor of the tank allows for a smaller sump area allowing for more of the concentrate to be used even in off angled situations.

Internal baffles also help with reducing sloshing liquid to provide a more consistent supply and a vent in the tank ensure a vacuum is not pulled on the tank.

After use, due to the caustic nature of the concentrate, the system may be cleaned out. In some arrangements, an integrated flush port allows a generic garden hose to be hooked up to allow drainage to a desired location while the tank is washed out.

In certain use case implementations, the vehicle may serve as a firefighting vehicle. Other use cases are suitable as well such as vehicles for chemical treatment, riot handling vehicles, and so on.

In the context of a firefighting robot, the vehicle is specially adapted to spray foam, water and/or other fluids on fires. In some arrangements, the robot vehicle is significantly smaller than a firetruck. Such a firefighting robot is maneuverable and able to aim water accurately at desired targets. The Thermite robot available from Howe & Howe, Incorporated of Waterboro, ME, is a remote controlled, tracked vehicle with a remotely aimed nozzle (monitor) that can discharge fluid in high capacity (e.g., 1,500 gallons of water per minute or more). The Thermite has the ability to withstand environments that are too hazardous for human personnel. Such a robot is suitable for use by various improvements disclosed herein.

As used within this document, the words “comprising,” “including,” “containing,” and “having” may be intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should not be interpreted as meaning “based exclusively on” but rather “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the disclosure. Such modifications and enhancements are intended to belong to various embodiments of the disclosure.

What is claimed is:

1. A foam concentrate tank assembly to mount to a vehicular robot, the foam concentrate tank assembly comprising:
a set of metal partitions defining a chamber to hold foam concentrate;
a set of baffles disposed within the chamber and coupled with the set of metal partitions; and
a set of mounting members external to the chamber and coupled with the set of metal partitions, the set of mounting members being constructed and arranged to be secured to the vehicular robot.

2. The foam concentrate tank assembly as in claim 1, further comprising:
an output port coupled with the set of metal partitions, the output port being constructed and arranged to output foam concentrate from the chamber.

3. The foam concentrate tank assembly as in claim 2 wherein the set of metal partitions includes:
a front partition that defines a front of the foam concentrate tank assembly,
a rear partition that defines a rear of the foam concentrate tank assembly, and
a bottom partition having a sloped bottom section which slopes from the rear partition toward the front partition.

4. The foam concentrate tank assembly as in claim 3 wherein the set of mounting members is constructed and arranged to orient the front partition adjacent to a front of the vehicular robot and the rear partition adjacent to a rear of the vehicular robot; and
wherein the output port is disposed on the front partition adjacent to the front of the vehicular robot.

5. The foam concentrate tank assembly as in claim 4 wherein the bottom partition further has a sump section adjacent the output port, the sloped bottom section pitching towards the sump section to collect foam concentrate within the chamber over the sump section and at the output port.

6. The foam concentrate tank assembly as in claim 3 wherein the set of metal partitions further includes:
a set of side partitions that defines a set of sides of the foam concentrate tank assembly; and
wherein the set of baffles includes:
a set of transverse baffles coupled with the set of side partitions that defines the set of sides of the foam concentrate tank assembly.

7. The foam concentrate tank assembly as in claim 6 wherein the set of baffles further includes:
at least one lateral baffle coupled with the front partition, the rear partition, and the set of transverse baffles.

8. The foam concentrate tank assembly as in claim 3 wherein the set of baffles includes multiple baffle members which define openings and which extend vertically within the chamber, the multiple baffle members being constructed and arranged to reduce foam concentrate movement within the chamber and provide strength to the set of partitions while also allowing foam concentrate to drain evenly within the chamber toward the output port.

9. The foam concentrate tank assembly as in claim 8 wherein the multiple baffle members are metallic and welded to the set of metal partitions defining the chamber.

10. The foam concentrate tank assembly as in claim 3 wherein the set of metal partitions further includes:
side partitions coupled with the front partition and the rear partition, and
a top partition coupled with the front partition, the rear partition, and the side partitions; and
wherein the foam concentrate tank assembly further comprises:
an input port disposed on the top portion, the input port being constructed and arranged to input foam concentration into the chamber.

11. The foam concentrate tank assembly as in claim 10 wherein the input port defines a first diameter;
wherein the output port defines a second diameter; and
wherein the first diameter is wider than the second diameter.

12. The foam concentrate tank assembly as in claim 10, further comprising:
a set of vents disposed on the top portion, the set of vents being constructed and arranged to allow air to enter the chamber to displace foam concentrate that leaves the chamber through the output port.

13. The foam concentrate tank assembly as in claim 3, further comprising:
a control valve coupled with the output port, the control valve being constructed and arranged to control flow of foam concentrate through the output port.

14. The foam concentrate tank assembly as in claim 13 wherein the control valve includes a mechanical handle which transitions the control value between an opened state that allows foam concentrate to flow through the output port and a closed state that prevents foam concentrate from flowing through the output port.

15. The foam concentrate tank assembly as in claim 13 wherein the control valve includes an electrical interface constructed and arranged to couple with an electronic controller of the vehicular robot to enable an operator of the vehicular robot to remotely control foam concentrate flow through the output port.

16. The foam concentrate tank assembly as in claim 13, further comprising:
a flush port constructed and arranged to drain the foam concentrate tank assembly, the flush port and the output port being disposed side-by-side along a bottom edge of the front partition with the output port being closer to a center of the vehicular robot and the flush port being further from the center of the vehicular robot when the foam concentrate tank assembly is mounted to the vehicular robot.

17. The foam concentrate tank assembly as in claim 13, further comprising:
a suction hose constructed and arranged to convey foam concentrate from the output port to a nozzle of the vehicular robot via suction from the nozzle.

18. The foam concentrate tank assembly as in claim 13 wherein the set of metal partitions further includes:
an inner side partition coupled with the front partition and the rear partition,
an outer side partition coupled with the front partition and the rear partition, the inner side partition being closer to a center of the vehicular robot than the outer side partition, and
a top partition coupled with the front partition, the rear partition, and the side partitions; and
wherein the foam concentrate tank assembly further comprises:
an insulative ceramic layer (i) covering the front partition, the rear partition, the outer side partition, and the top partition and (ii) not covering the inner side partition and the bottom partition.

19. A robotic foam delivery system, comprising:
a vehicular robot;
a foam concentrate tank assembly; and
hardware which mounts the foam concentrate tank assembly to the vehicular robot, the foam concentrate tank assembly including:
a set of metal partitions defining a chamber to hold foam concentrate,
a set of baffles disposed within the chamber and coupled with the set of metal partitions, and
a set of mounting members external to the chamber and coupled with the set of metal partitions, the set of mounting members being constructed and arranged to be secured to the vehicular robot by the hardware.

20. A method of provisioning a vehicular robot with foam concentrate, the method comprising:
mounting a foam concentrate tank assembly to the vehicular robot, the foam concentrate tank assembly including:
a set of metal partitions defining a chamber to hold foam concentrate,
a set of baffles disposed within the chamber and coupled with the set of metal partitions, and
a set of mounting members external to the chamber and coupled with the set of metal partitions, the set of mounting members being constructed and arranged to be secured to the vehicular robot when the foam concentrate tank assembly is mounted to the vehicular robot;
connecting the foam concentrate tank assembly to a nozzle of the vehicular robot, the nozzle being constructed and arranged to spray a mixture of foam concentrate from the foam concentrate tank assembly and water on a target area; and
filling at least a portion of the chamber defined by the set of metal partitions with foam concentrate.
